(19) United States
(12) Patent Application Publication
(10) Pub. No.: US 2017/0131030 A1
(43) Pub. Date: May 11, 2017

(54) GRAIN DRYING CONTROL SYSTEM

(71) Applicant: SUKUP MANUFACTURING CO., Sheffield, IA (US)

(72) Inventors: Matthew Koch, Clear Lake, IA (US); Graham Giddings, Sheffield, IA (US)

(21) Appl. No.: 14/934,900

(22) Filed: Nov. 6, 2015

(51) Int. Cl. F26B 25/22; G01N 27/22; F26B 17/18

(52) U.S. Cl. CPC F26B 25/22; F26B 17/18; G01N 27/223; F26B 2200/06

(57) ABSTRACT

A grain drying control system including a grain drying device, a plurality of sensors associated with the grain drying device and a computer. The computer controls the grain drying device based on the data transmitted from the sensors related to ambient conditions, grain temperature and moisture, and unload speed to achieve a desired grain moisture.

### BACKGROUND OF THE INVENTION

This invention is directed toward a system for drying grain and more particularly a system that utilizes multiple operating sensors to control the grain drying system.

Well-known in the art are control systems that utilize moisture sensors on the discharge and/or inlet of a grain dryer. Other control systems have utilized sensors at different locations along the drying process. While useful, these systems are limited with respect to maintaining grain quality, are expensive to use, and are not as accurate as desired. Therefore a need exists in art for a control system that addresses these deficiencies.

To address this need, an objective of the present invention is to provide a grain drying control system that is more efficient.

Another objective of the present invention is to provide a grain drying control system that maximizes grain quality.

A still further objective of the present invention is to provide a grain drying control system that maximizes moisture accuracy.

These and other objectives will be apparent to one of ordinary skill in the art based upon the following written description, drawings, and claims.

### SUMMARY OF THE INVENTION

A grain drying control system includes a gain drying device having at least one column with an input port and a discharge port. Adjacent the input port is an input hopper and an input auger and adjacent the discharge port is a discharge hopper and a discharge auger that extends through a discharge tube.

A plurality of sensors are disposed within the grain drying device to measure grain temperature and moisture at various points in the grain drying process. Additional sensors are positioned outside the grain drying device to measure ambient temperature and moisture. Also, sensors are connected to the discharge auger and/or at least one metering roll within a column to measure rotational speed. All sensors transmit data to a computer wherein the computer controls the grain drying process based upon the transmitted data.

### BRIEF DESCRIPTION OF THE DRAWINGS

FIG. 1 is an end sectional view of a grain drying control system; and

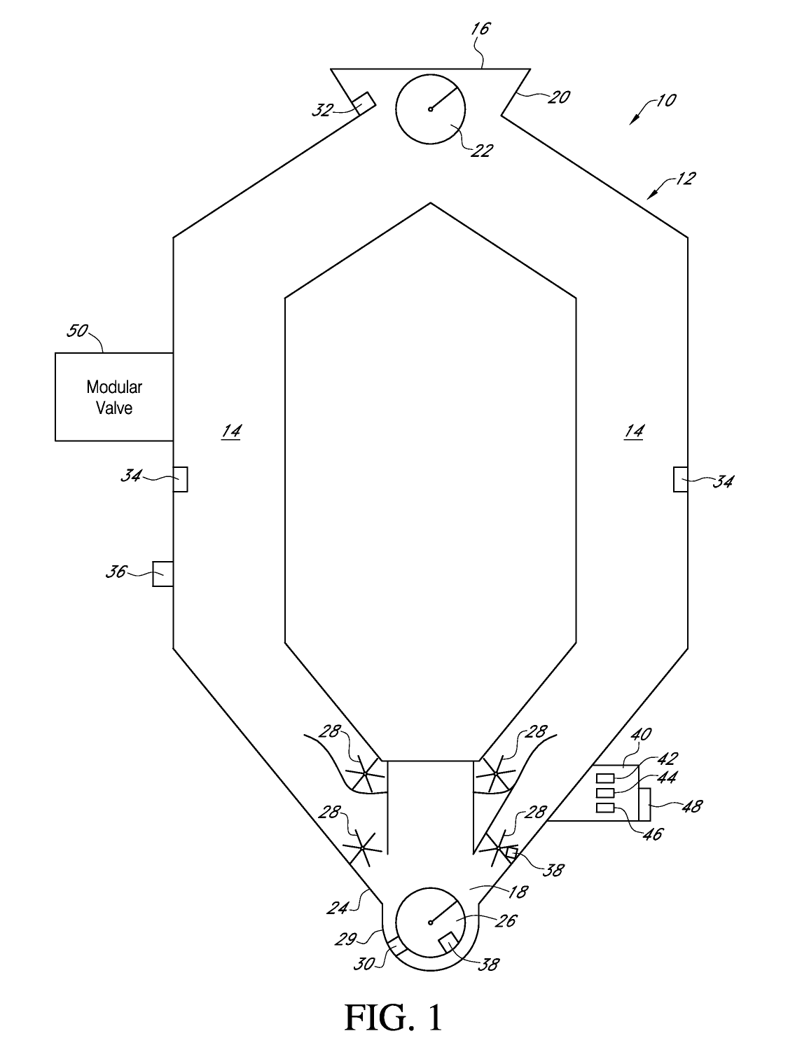

FIG. 2 is a side sectional view of a grain drying control system.

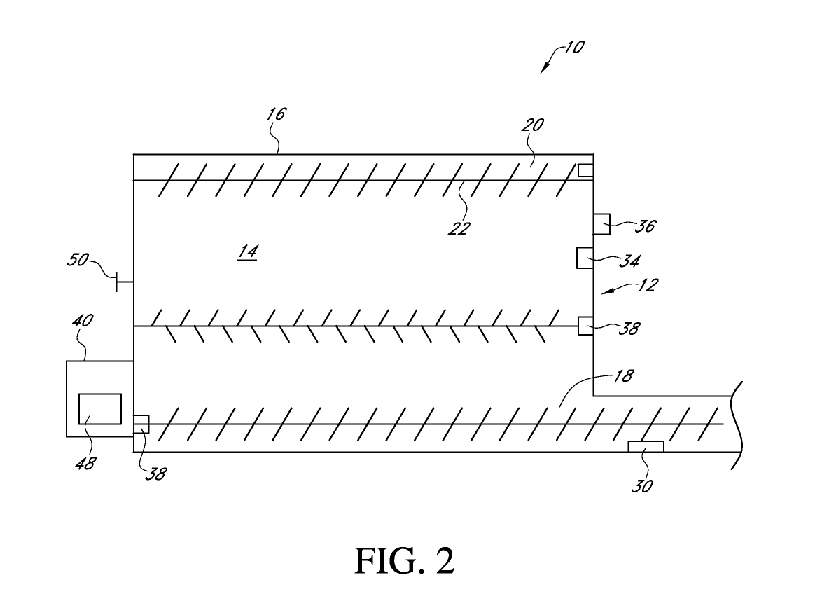

### DETAILED DESCRIPTION OF THE PREFERRED EMBODIMENT

Referring to the figures, a grain drying control system 10 is used with a grain drying device 12. The grain drying device is of any type, and by way of example only, the grain drying device 12 has at least one conduit or column 14 having an inlet port 16 and an outlet port 18. The inlet port 16 has an inlet hopper 20 and an inlet grain feeding auger 22. The discharge port 18 has a discharge hopper 24 and a discharge auger 26. The lower end of column 14 has at least one metering roll 28. The discharge auger 26 extends through a discharge tube or conduit 29.

A plurality of sensors are positioned about the grain drying device 12. A first sensor 30 is positioned within an opening of the discharge tube 29. The sensor 30 is of any type and preferably the sensor includes a modular interface fully encapsulated circuit board such as the sensor disclosed in U.S. Ser. No. 14/736,492 which is hereby incorporated by reference in its entirety.

A second sensor 32 is positioned at the inlet port 16 of dryer 12 to measure the inlet moisture of the grain as the grain enters the dryer 12. The second sensor 32 can be the same type as the first sensor 30 or different.

A third sensor 34 is positioned within the column 14 to measure grain temperature within the column 14 and a fourth sensor 36 is positioned outside the dryer 12 to measure ambient temperature and humidity. Finally, a fifth sensor 38 is connected to the discharge auger 26 and/or the metering roll 28 to measure unload speed.

All sensors 30, 32, 34, 36, and 38 are connected to a computer 40 having a processor 42, memory 44, and software 46. An input device 48 such as a touch screen is associated with the computer 40. The computer 40 is also operatively connected to the discharge auger and the metering roll 28.

In operation, a person enters a desired moisture content of dried grain using the input device 48. As grain is input into the dryer 12, the second sensor 32 transmits data to the computer 40 about the input moisture of the grain. The third and fourth sensors 34 and 36 transmit data to the computer 40 about the grain temperature in the column 14 and the ambient temperature and humidity.

The first sensor 30 transmits data to the computer 40 about the moisture and temperature of the grain in the discharge tube 26. Finally, the fifth sensor 38 transmits data to the computer 40 about the rotational speed of the discharge auger 26 and/or the meeting roll 28.

Based upon some or all of the transmitted data, the computer 40 sends a signal adjusting the rotational speed of the discharge auger 26 and/or the metering roll 28 so that the desired moisture content of the dried grain is obtained. Additionally, or alternatively, the computer 40 sends a signal to a modular valve 50 to adjust the temperature supplied to column 14.

Accordingly, a grain drying system has been disclosed that at the very least meets all the stated objectives.

What is claimed is:

1. A grain drying control system, comprising:
a grain drying device having a column with an input and discharge port and a discharge tube; a plurality of sensors positioned at least at the inlet port, within the column, and within the discharge tube;
a computer connected to the plurality of sensors and the grain drying device that controls the operation of the grain drying device to dry grain to a desired moisture based upon data transmitted from the sensors to the computer;

2. The control system of claim 1 wherein a discharge auger is disposed within the discharge tube and at least one metering roll is disposed within the column adjacent the discharge port.

3. The control system where at least one of the plurality of sensors includes a modular interface fully encapsulated circuit board.

4. The control system of claim 1 wherein the plurality of sensors measure grain moisture and temperature in the tube, grain moisture at input, grain temperature within the column, ambient temperature and humidity, and unload speed.
